(19) United States
(12) Patent Application Publication
(10) Pub. No.: US 2015/0337774 A1
(43) Pub. Date: Nov. 26, 2015

(54) UNBURNED FUEL VENTING IN INTERNAL COMBUSTION ENGINES

(71) Applicant: CATERPILLAR ENERGY SOLUTIONS GMBH, Mannheim (DE)

(72) Inventor: Karl STELLWAGEN, Frankenthal (DE)

(73) Assignee: Caterpillar Energy Solutions GmbH, Mannheim (DE)

(21) Appl. No.: 14/652,766

(22) PCT Filed: Dec. 20, 2013
(86) PCT No.: PCT/EP2013/003928

§ 371 Date: Jun. 16, 2015

(30) Foreign Application Priority Data
Dec. 21, 2012 (EP) 12198.864.6

(51) Int. Cl. F02M 25/07; F02F 1/00

(52) U.S. Cl. CPC F02M 25/0747; F02M 25/072; F02F 1/004

(57) ABSTRACT

An internal combustion engine is disclosed. The engine may have a cylinder. The engine may also have a piston reciprocally movable within the cylinder between a top dead center (TDC) and a bottom dead center (BDC). The piston may separate the cylinder into an upper piston section and a lower piston section. The piston may have a piston ring assembly with a piston ring configured to sealingly contact the cylinder. The piston ring assembly may have a thickness (D). The engine may have an annular crevice in fluid communication with the upper piston section. The engine may also have a plurality of venting grooves that may fluidly connect the annular crevice with the lower piston section, only when the crank angle ranges from about 85° to 95° and about 265° to 275° after the top dead center (TDC).

### TECHNICAL FIELD

The present disclosure generally relates to an internal combustion engine comprising at least one flow channel for venting unburned air/fuel-mixture out of a combustion chamber.

### BACKGROUND

During operation of internal combustion engines, exhaust gases may include quench gases from the combustion chamber surfaces and crevice volumes in the spaces between the piston and cylinder wall where unburned fuel, especially unburned air/fuel-mixture, is present after the end of combustion in the engine cylinders. Therefore, it is desired to gain the amount of unburned air/fuel-mixture and to recycle the same during a subsequent combustion cycle.

For example, U.S. Pat. No. 4,191,150 A discloses an engine with selective venting of unburned mixture from the piston crevice volume. Particularly, venting means include one or more bypass channels in the cylinder wall which bypasses the piston rings and connects the crevice volume with the engine crankcase in the lower portions of the piston stroke. The mixture is removed during the latter portion of the power stroke.

U.S. Pat. No. 5,37,919 A discloses a hydrocarbon emission control for a four-stroke spark ignited internal combustion engine having a variable volume chamber and an auxiliary chamber with a fixed volume which is smaller than the maximum volume of the working chamber. The working chamber and the auxiliary chamber are connected to each other by a series of passages in the cylinder wall, wherein the passages in the cylinder wall are situated such that when the piston is near the top of its exhaust stroke, the end gases stored in the auxiliary chamber are discharged into the crankcase.

U.S. Pat. No. 6,431,157 B1 discloses an internal combustion engine comprising a cylinder block with at least one cylinder barrel, a cylinder head with at least one inlet channel and exhaust channel with related inlet and exhaust valves to a combustion chamber situated above a piston moveable in the cylinder barrel and a crankcase for lubricating oil situated below the piston. The piston includes at least two grooves situated at a distance from each other, each having a piston ring and a piston collection chamber contained between the rings.

US 2009/0126672 discloses a handheld work apparatus having an internal combustion engine and a starter device. In order to avoid a delay when starting the engine, at least one recess is provided in the cylinder bore which bridges the at least one piston ring in at least one position of the piston.

JP S62 26346 A discloses a reciprocating piston type engine equipped with a piston, a cylinder cover, and a cylinder liner. A one-stage gas blowing-out passage is formed onto the cylinder liner. In the gas blowing-out passage, a recessed part having the dimension a little larger than the width of a piston ring is formed into the circumference of the cylinder liner. Thus, the load in each stage of the piston rings is levelled.

The present disclosure is directed, at least in part, to improving or overcoming one or more aspects of prior systems.

### SUMMARY OF THE DISCLOSURE

According to an aspect of the present disclosure, an internal combustion engine may comprise a cylinder, a piston reciprocally movable within the cylinder between a top dead center and a bottom dead center, wherein the piston may separate the cylinder into an upper piston section and a lower piston section. The piston may include a piston ring assembly having at least one piston ring configured to sealingly contact the cylinder and having a piston ring assembly thickness. The internal combustion engine may further comprise an annular crevice having an annular crevice volume and being in fluid communication with the upper piston section and being defined by the cylinder, the piston and the piston ring assembly, and a plurality of venting grooves each extending within in the cylinder in axial direction over a length being greater than the piston ring assembly thickness. The plurality of venting grooves may include a venting volume and may be configured and positioned to fluidly connect the annular crevice with the lower piston section, when the piston has a position corresponding to a crank angle range of about 85° to 95° and about 265° to 275° after the top dead center. The venting volume of the plurality of venting grooves may be within the range from about 15% to 60% of the annular crevice volume.

According to another aspect of the present disclosure, an internal combustion engine may comprise a cylinder, a piston reciprocally movable within the cylinder between a top dead center and a bottom dead center, wherein the piston may separate the cylinder into an upper piston section and a lower piston section. The piston may include at least one piston ring configured to sealingly contact the cylinder and having a piston ring thickness. The internal combustion engine may further comprise an annular crevice being in fluid communication with the upper piston section and being defined by the cylinder, the piston and the at least one piston ring, and a plurality of venting grooves vertically disposed in the cylinder and each having a length being greater than the piston ring thickness. The plurality of venting grooves may be configured and positioned to fluidly connect the annular crevice with the lower piston section, when the piston has a position corresponding to a crank angle range of about 85° to 95° and about 265° to 275° after the top dead center.

According to another aspect of the present disclosure, a method for operating an internal combustion engine including a cylinder defining a combustion chamber within, a piston reciprocally movable within the cylinder between a top dead center and a bottom dead center, and an inlet channel configured to supply a predetermined amount of an air/fuel-mixture into the combustion chamber may comprise directing unburned air/fuel-mixture out of an annular crevice formed between the cylinder and the piston and being in fluid communication with the combustion chamber into the intake channel, only when the piston has a position corresponding to a crank angle range of about 85° to 95° after the top dead center during a power stroke of the internal combustion engine.

According to another aspect of the present disclosure, a cylinder liner configured to be inserted into a cylinder of an internal combustion engine may comprise a circumferential wall configured to reciprocally guide a piston between a top dead center and a bottom dead center. The piston may separate the cylinder liner into an upper piston section and a lower piston section, and may include a piston ring assembly having at least one piston ring configured to sealingly contact the circumferential wall and having a piston ring assembly thickness such that an annular crevice is defined by the circumferential wall, the piston, and the piston ring assembly. The annular crevice may have an annular crevice volume. The cylinder liner may further comprise a plurality of venting grooves each extending within in the cylinder in axial direction over a length being greater than the piston ring assembly thickness. The plurality of venting grooves may have a venting volume and may be configured and positioned to fluidly connect the annular crevice to the lower piston section, only when the piston may have a position corresponding to a crank angle range of about 85° to 95° and about 265° to 275° after the top dead center. The venting volume may be within the range from about 15% to about 60% of the annular crevice volume.

According to another aspect of the present disclosure, a cylinder liner configured to be inserted into a cylinder of an internal combustion engine may comprise a circumferential wall configured to reciprocally guide a piston between a top dead center and a bottom dead center. The piston may separate the cylinder liner into an upper piston section and a lower piston section, and may include at least one piston ring configured to sealingly contact the circumferential wall and having a piston ring thickness, such that an annular crevice may be defined by the circumferential wall, the piston, and the at least one piston ring, and may include an annular crevice volume. The disclosed cylinder liner may further comprise a plurality of venting grooves vertically disposed in the circumferential wall. Each of the plurality of venting grooves may have a length being greater than the piston ring thickness, wherein the plurality of venting grooves may have a venting volume and may be configured and positioned to fluidly connect the annular crevice to the lower piston section, only when the piston has a position corresponding to a crank angle range of about 85° to 95° and 265° to 275° after the top dead center. The venting volume may be at least 15%, particularly at least 20%, of the annular crevice volume.

In some embodiments, the length of each of the plurality of venting grooves may be at maximum about 50% greater than the piston ring thickness or the piston ring assembly thickness, respectively.

In some embodiments, the internal combustion engine may further comprise a cylinder liner inserted into the cylinder, such that the piston is reciprocally disposed within the cylinder liner and the annular crevice is defined by the cylinder liner, the piston and the piston ring assembly, wherein the plurality of venting grooves is vertically disposed in the cylinder liner.

In some embodiments, the piston may comprise a plurality of piston rings configured to sealingly contact the cylinder. In such embodiments, the piston ring thickness may be defined by the distance between an upper edge of the uppermost piston ring and a lower edge of the lowermost piston ring.

Other features and aspects of this disclosure will be apparent from the following description and the accompanying drawings.

### BRIEF DESCRIPTION OF THE DRAWINGS

FIG. 1 shows a schematic view of an exemplary disclosed internal combustion engine;

FIG. 2 shows a schematic view of an detail II-II of the internal combustion engine of FIG. 1; and

FIG. 3 is a graphical illustration associating the leakage area between the upper portion and lower portion of the piston in dependency of the crank angle during a four-stroke cycle.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure may be based in part on the realization that providing a cylinder of an internal combustion with a plurality of vertical venting grooves situated such that each of the plurality of venting grooves fluidly connects an annular crevice trapping unburned air/fuel-mixture at a piston reciprocally disposed within the cylinder with a portion below the piston, when the piston has a position corresponding to a crank angle range of about 85° to 95° after the top dead center during a power stroke of the internal combustion engine, may release unburned fuel from the annular crevice and, thus, may prevent exhausting the unburned air/fuel-mixture. Furthermore, this may increase the efficiency of the internal combustion engine.

The present disclosure may be further based in part on the realization that the internal combustion engine may also be provided with a cylinder liner being inserted into the cylinder. In such case, the cylinder liner includes the plurality of vertical venting grooves of which each is configured to fluidly connect the annular crevice with the lower piston portion. Also in such case, the unburned air/fuel-mixture trapped in the annular crevice formed by the cylinder liner and the piston reciprocally disposed within the cylinder liner may be released out of the combustion chamber and may be re-supplied for combusting in a subsequent combustion cycle.

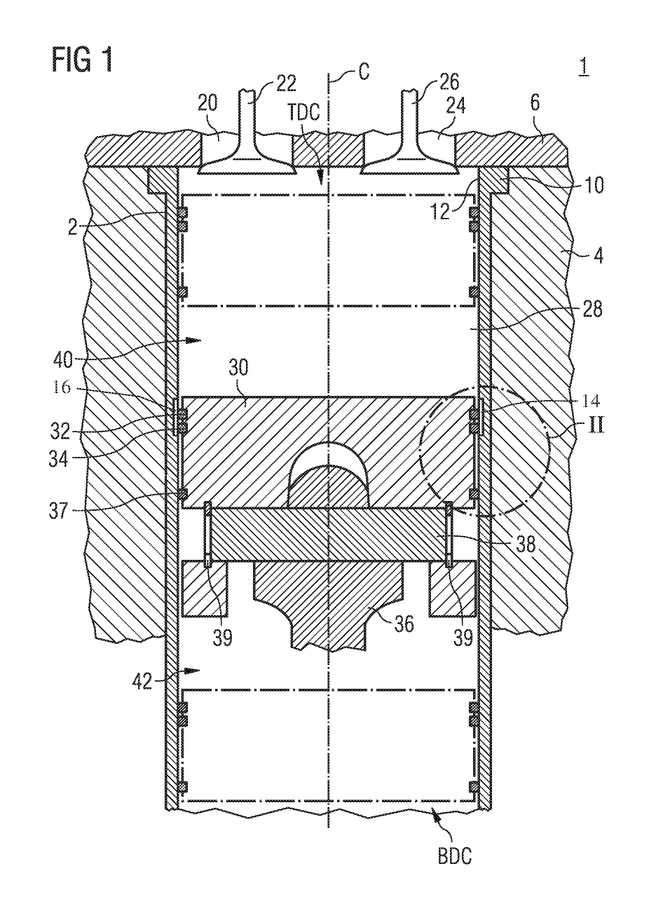

Referring now to the drawings, a cylinder liner 10 inserted into a cylinder 2 of an engine block 4 of an internal combustion engine 1 is illustrated in FIG. 1. However, as already mentioned above, the present disclosure may be also applicable to internal combustion engines that may not comprise a cylinder liner.

The internal combustion engine 1 may include features not shown, such as fuel systems, air systems, cooling systems, peripheries, drive train components, etc. For the purposes of the present disclosure, the internal combustion engine 1 is considered as a four-stroke gaseous fuel internal combustion engine. One skilled in the art will recognize, however, that the internal combustion engine 1 may be any type of engine (gas, diesel, natural gas, propane, dual fuel, etc.) that would utilize ventilation of unburned air/fuel mixture out of the crevice volume from the combustion chamber. Furthermore, the gaseous fuel internal combustion engine 1 may be of any size, with any number of cylinders, and in any configuration (“V,” in-line, radial, etc.).

The internal combustion engine 1 may be used to power any machine or other device, including locomotive applications, on-highway trucks or vehicles, off-highway trucks or machines, earth moving equipment, generators, aerospace applications, marine applications, pumps, stationary equipment, or other engine powered applications.

The cylinder liner 10 including a circumferential wall 12 defining a combustion chamber 28 therein is sealingly inserted into the cylinder 2. Particularly, sealing rings (not explicitly shown in the drawings) may be configured to seal between the cylinder liner 10 and the cylinder 2.

As shown in FIG. 1, a cylinder head 6 is configured to close an upper end of the cylinder 2 and the cylinder liner 10. The cylinder head 6 is provided with an inlet channel 20 and an outlet channel 24 being provided with an intake valve 22 and an exhaust valve 26, respectively. The intake valve 22 is configured to open and close the inlet channel 20, thereby enabling or restricting air/fuel-mixture to enter the combustion chamber 28. The exhaust valve 26 is configured to open and close the outlet channel 24, thereby enabling or restricting exhaust gas to leave the combustion chamber 28. An engine control unit (not explicitly illustrated in the drawings) may be configured to control the intake valve 22 and the exhaust valve 26, respectively.

A piston 30 is reciprocally disposed within the cylinder liner 10 along an axis C and is movable between a top dead center (in the following referred to as TDC) and a bottom dead center (in the following referred to as BDC). Specifically, the piston 30 separates the volume of the cylinder liner 10 into an upper piston section 40 defining the combustion chamber 28, and a lower piston section 42 positioned below the piston 30. The piston 30 is configured to vary the volume of the combustion chamber 28 by reciprocally moving between the TDC and the BDC. The piston 30 is further indicated as being positioned in the TDC, which means near the intake valve 22 and the exhaust valve 26, and the BDC, which means the point farthest away from the intake valve 22 and exhaust valve 26. Both positions of the piston 30 the TDC and the BDC are indicated by dotted lines in FIG. 1.

As shown in FIG. 1, the piston 30 includes a top end 31 facing the combustion chamber 28. The piston 30 is provided with a piston ring assembly having a first piston ring 32 and a second piston ring 34 disposed below the first piston ring 32. The first piston ring 32 and the second piston ring 34 are both configured to seal the combustion chamber 28 against the lower piston section 42, which includes sealing against the crankcase. The piston 30 further includes at least one scraping piston ring 37 configured to wipe over the inner wall of the cylinder, thereby wiping lubricating oil. As the scraping piston ring 37 is not a sealing piston ring as the first and second piston rings 32, 34, gaseous fluids, such as, for example, unburned air/fuel-mixture and exhaust gas, may be enabled to freely pass the scraping piston ring 37.

In some embodiments, the piston 30 may be provided with only one piston ring, such as, for example, only the first piston ring 32. In such case, the only one piston ring is configured to sealingly contact the cylinder 2 and, therefore, to seal the upper piston section 40 against, for example, the crankcase.

The cylinder liner 10 includes a plurality of venting grooves 14, 16 vertically disposed in the circumferential wall 12. Regarding FIG. 1, two venting grooves 14 and 16 are shown. However, in some embodiments, the cylinder liner 10 may comprise less or more than two venting grooves 14, 16. For example, the cylinder liner 10 may comprise six venting grooves symmetrically disposed about the circumference of the cylinder liner 10. The plurality of venting grooves 14, 16 is configured to release unburned air/fuel-mixture out of the combustion chamber 28 and to direct the unburned air/fuel-mixture into the lower piston section 42.

In dependency of the diameter of the cylinder liner 10, the number of provided venting grooves 14, 16 may be chosen such that the total venting volume of all venting grooves is at least 15%, particularly at least 20%, of the annular crevice volume. For example, the total venting volume of all venting grooves is within the range from 20% to 60% or within the range from 30% to 50% or about 30% of the annular crevice volume. In some embodiments, the cylinder liner 10 has a diameter in the range from, for instance, 120 mm to 300 mm and may include more than 10, 20, 30, or even more venting grooves 14, 16. The arrangement may be symmetrically disposed about the circumference of the cylinder liner 10. Particularly, each of the venting grooves 14, 16 may have a cross-sectional area of, for example, about 1 mm² and a length of, for instance, about 20 mm.

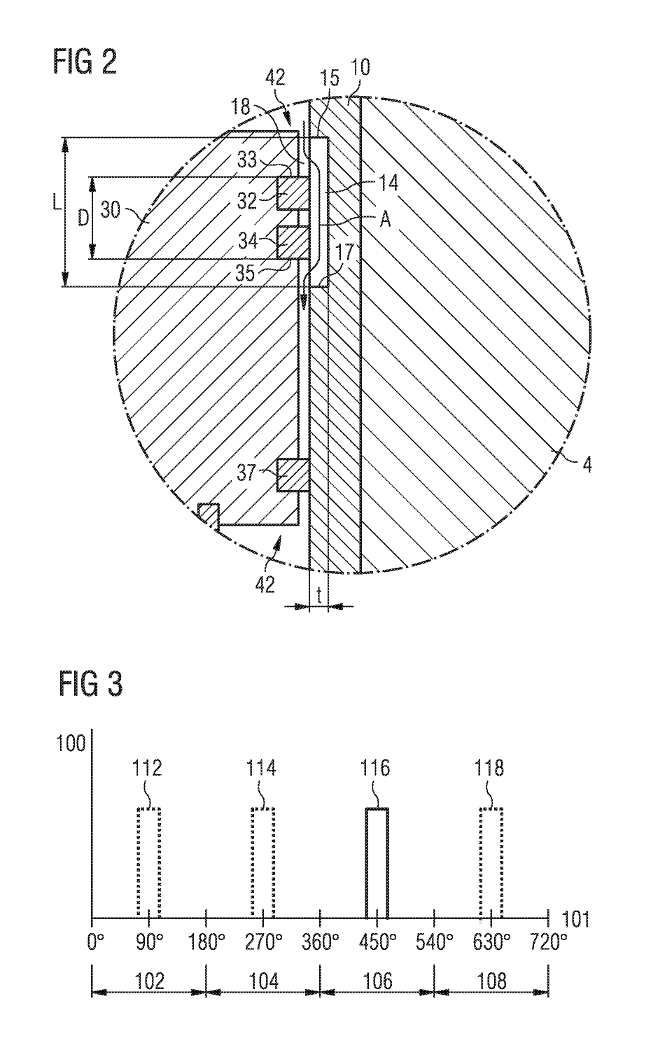

Regarding FIG. 2, an enlarged view of the venting groove 14 is shown. As illustrated, an annular crevice 18 is formed at the piston 30. Particularly, the annular crevice 18 is defined by the cylinder liner 10, the circumference of the piston 30, the first piston ring 32 and an imaginary elongation of the top end 31 of the piston 30. In some embodiments, which do not utilize a cylinder liner 10, the annular crevice 18 may be defined by an inner wall of the cylinder 2, the circumference of the piston 30, the first piston ring 32 and an imaginary elongation of the top end 31 of the piston 30.

The annular crevice 18 has an annular crevice volume. The annular crevice 18 may have a thickness defined by the distance between the piston 30 and the inner wall of the cylinder liner 10 or the inner wall of the cylinder 2, and a height defined by the distance between the top end 31 of the piston 30 and the top end of the first piston ring 32. The thickness of the annular crevice 18 may range from, for example, about 0.1 mm to about 0.5 mm, and the height of the annular crevice 18 may range from, for instance, about 10 mm to about 30 mm. The inner diameter of the annular crevice 18, which is the diameter of the piston 30, may range from, for example, about 130 mm to about 300 mm.

With respect to the above indicated parameters for the venting grooves, the venting volume of the plurality of venting grooves may be at least 15%, particularly at least 20%, of the annular crevice volume.

A piston rod 36 is connected to the piston 30 by a piston pin 38 being axially secured by two locking rings 39. The piston rod 36 is configured to be connected to a crankshaft (not shown in the drawings) disposed within a crankcase (not shown) of the engine block 4, such that rotation of the crankshaft results in a reciprocating motion of the piston 30 within the cylinder liner 10. The person skilled in the art will recognize that, at a crank angle of 0°, the piston 30 may be positioned at the TDC, and at a crank angle of 180°, the piston 30 may be positioned at the BDC.

The first piston ring 32 and the second piston ring 34 are spaced apart from each other by a piston ring thickness D. Particularly, the piston ring thickness D may be defined by an upper edge 33 of the first piston ring 32 and a lower edge 35 of the second piston ring 34.

In some embodiments, where only one sealing piston ring is provided, the piston ring thickness D may be defined by the thickness of the only one sealing piston ring, in particular, by the upper edge and the lower edge of the only one sealing piston ring.

The venting groove 14 may comprise a length L in the vertical direction parallel to the axis C and a depth t extending perpendicular to the axis C. The length L of each of the venting grooves 14, 16 may be at maximum 50%, preferably at maximum 25% greater than the piston ring thickness D, such that the upper piston section 40 is fluidly connected to the lower piston section 42 during limited portions of the four-stroke cycle, which will be described in more detail below.

As shown in FIG. 2, the venting groove 14 may comprise a rectangular shape in the illustrated view, such that an upper edge 15 of the venting groove 14 extends perpendicular with respect to the axis C. However, in some embodiment, the upper edge 15 may also be provided in a sloped shape, such that the cross-section in a downward direction is continuously enhanced until the depth t of the venting groove 14 is reached. Similarly, the venting groove 14 may further include a lower edge 17 that may also extend perpendicular with respect to the axis C. In some embodiments, similarly to the upper edge 15, the lower edge 17 may also comprise a sloped shape.

The plurality of venting grooves 14, 16 are configured to fluidly connect the annular crevice 18 with the lower piston section 42, when the piston 30 is situated such that the crank angle is in a range from about 85° to 95° after the TDC, particularly during the power stroke of the internal combustion engine 1, which will be described in more detail below. The downward flow of the unburned air/fuel-mixture bypassing the piston 30 is indicated in FIG. 2 by an arrow A.

After venting the unburned air/fuel-mixture from the annular crevice 18 out of the combustion chamber 28 into the lower piston section 42, the unburned air/fuel-mixture may be re-supplied to the inlet channel 20 and, thus, to the combustion chamber 28 during a subsequent combustion cycle. Therefore, the vented unburned air/fuel-mixture may be firstly directed into the crankcase, where the unburned air/fuel-mixture may be accumulated. Subsequently, the accumulated air/fuel-mixture within the crankcase may then be re-supplied to the combustion chamber 28 via the inlet channel 20.

It is noted that the internal combustion engine 1 may be provided without a cylinder liner 10. In such case, the plurality of venting grooves 14, 16 may be provided in the cylinder 2, such that the annular crevice 18 is fluidly connected to the lower piston section 42, when the piston 30 is in the same position as mentioned above, namely when the crank angle is in a range from about 85° to 95°.

### INDUSTRIAL APPLICABILITY

In the following, operation of the internal combustion engine 1 is described with reference to FIGS. 1 to 3.

Referring to FIG. 3, a diagram is shown, wherein the ordinate 100 constitutes the portion in which the annular crevice 18 is in fluid communication with the lower piston section 42 via the venting grooves 14, 16, and the abscissa 101 constitutes the crank angle over a complete four-stroke cycle including an intake stroke 102, a compression stroke 104, a power stroke 106, and an exhaust stroke 108, wherein a crank angle of 0° indicates the begin of the intake stroke and a crank angle of 720° indicates the end of the exhaust stroke and, thus, the end of the complete four-stroke cycle.

Specifically, during a crank angle range from 0° to 180°, the four-stroke cycle is in the intake stroke 102. During a crank angle range from 180° to 360°, the four-stroke cycle is in the compression stroke 104. During a crank angle range from 360° to 540°, the four-stroke cycle is in the power stroke 106. During a crank angle range from 540° to 720°, the four-stroke cycle is in the exhaust stroke 108.

Furthermore, at crank angles of 0°, 360° and 720°, the piston 30 is at the TDC, which means at the upper position indicated by the dotted lines in FIG. 1, whereas at crank angles of 180° and 540°, the piston 30 is at the BDC, which means at the lower position indicated by the dotted lines in FIG. 1.

As already mentioned above, at a crank angle of 0°, the four-stroke cycle starts with the intake stroke 102. At this time, the piston 30 is in the TDC and begins to move downwardly. Then, the intake valve 22 opens, such that, during the intake stroke 102, a predetermined amount of the air/fuel mixture is injected into the combustion chamber 28. The predetermined amount of the air/fuel-mixture may be provided under a predetermined intake pressure originating from, for example, a turbocharger unit of the internal combustion engine 1. At this time, the exhaust valve 26 is closed.

When the crank angle reaches about 85°, which means 85° after the TDC during the intake stroke 102, the annular crevice 18 gets in fluid communication with the lower piston section 42, such that a small amount of the air/fuel-mixture may bypass the piston into the lower piston section 42. The leakage of air/fuel-mixture at this time is indicated by a first dotted line 112 in FIG. 3. Specifically, when the upper edge 33 of the first piston ring passes the upper edge 15 of the venting groove 14, the air/fuel-mixture is allowed to bypass the piston into the lower piston section 42, as the length L of each of the plurality of venting grooves 14, 16 is greater than the piston ring thickness D.

Then, when the crank angle reaches about 95°, which means 95° after the TDC during the intake stroke 102, the lower edge 35 of the second piston ring 34 passes the lower edge 17 of the venting groove 14, such that the air/fuel-mixture is restricted from bypassing the piston 30.

After passing the BDC at a crank angle of 180°, the piston 30 moves upwardly and the compression stroke 104 starts. Thus, at least at that time, the intake valve 22 closes such that the piston 30 compresses the air/fuel-mixture within the combustion chamber 28 while moving upwardly. During the compression stroke 104, the pressure of the air/fuel-mixture within the combustion chamber 28 may continuously increase, as the volume of the combustion chamber 28 continuously decreases during the upward movement of the piston 30. The pressure within the combustion chamber 28 may depend on the engine load. Thus, it may be desired that the combustion chamber pressure corresponds to the actual charge pressure.

When reaching a crank angle of 265°, which means a crank angle of 265° after the TDC, the lower edge 35 of the second piston ring 34 passes the lower edge 17 of the venting groove 14, such that the upper piston section 40, particularly the annular crevice 18, gets again in fluid communication with the lower piston section 42. This is indicated by a second dotted line 114 in FIG. 3.

At that time, a small amount of compressed air/fuel-mixture may flow out of the upper piston section 40 into the lower piston section 42 via the plurality of venting grooves 14, 16, as the pressure within the upper piston section 40 is higher than the pressure within the lower piston section 42, due to the compression of the air/fuel-mixture. Therefore, this amount of air/fuel-mixture leakage may be considered during injection of the air/fuel-mixture during the intake stroke 102. Namely, an increased amount of the air/fuel-mixture may be injected. However, the added injected air/fuel-mixture amount may be regained as described below.

When reaching a crank angle of about 275°, which means a crank angle of about 275° after the TDC, the upper edge 33 of the first piston ring 32 passes the upper edge 15 of the venting groove 14, such that the annular crevice 18 gets out of fluid communication with the lower piston section 42, thereby restricting the air/fuel-mixture to drain out of the upper piston section 40 into the lower piston section 42.

During the compression stroke 104, especially during a crank angle range of about 275° to 360°, which means a crank angle range of about 275° to 360° after the TDC, at least some amount of the air/fuel-mixture may be urged into the annular crevice 18. As the first piston ring 32 sealingly contacts the cylinder liner 10, the air/fuel-mixture trapped within the annular crevice 18 is restricted to flow further downwardly.

When reaching a crank angle of 360°, the piston 30 is in the TDC and the ignition may start. A spark plug (not shown) may provide a spark igniting the air/fuel-mixture within the combustion chamber 28. The burning mixture may expand and, thus, may urge the piston 30 downwardly, which means that the power stroke 106 starts.

However, as the burning fuel may be at least partially quenched when contacting the piston, the air/fuel-mixture trapped within the annular crevice 18 may not be ignited and, thus, may maintain unburned. Further, the expanding burning fuel may additionally urge unburned air/fuel mixture into the annular crevice 18 and may further compress the same.

When reaching a crank angle of about 445°, which means a crank angle of about 85° after the TDC during the power stroke 106, the upper edge 33 of the first piston ring 32 passes the upper edge 15 of the venting groove 14, such that the annular crevice 18 gets again in fluid communication with the lower piston section 42. This is indicated by the solid line 116 of FIG. 3. As the pressure of the unburned air/fuel mixture at this time may be, for example, about 20 bar, the unburned air/fuel-mixture trapped within the annular crevice 18 flows out of the combustion chamber 28 into the plurality of venting grooves 14, 16 and into the lower piston section 42.

The unburned air/fuel-mixture may downwardly flow into the lower piston portion until the crank angle reaches about 455°, which means a crank angle of 95° after the TDC during the power stroke 106. Then, the lower edge 35 of the second piston ring 34 passes the lower edge 17 of the venting groove 14, such that the fluid communication between the annular crevice 18 and the lower piston section 42 is interrupted.

Therefore, when the crank angle is in a range from about 445° to 455°, which means in a range from about 85° to 95° after the TDC during the power stroke 106, the annular crevice 18 is in fluid communication with the lower piston section 42, such that the unburned amount of air/fuel-mixture accumulated within the annular crevice 18 may be regained.

Subsequently, when reaching a crank angle of 540°, which means that the piston 30 is in the BDC, the exhaust stroke 108 starts and the piston 30 begins to move upwardly again. At this time, the exhaust valve 26 opens and the piston 30 urges the exhaust gas out of the combustion chamber 28 through the outlet channel 24.

During a crank angle range from about 625° to 635°, which means a crank angle range from about 265° to 275° after the TDC, the lower edge 35 of the second piston ring 34 passes the lower edge 17 of the venting groove 14, such that the annular crevice 18 is again in fluid communication with the lower piston section 42, which is indicated by a third dotted line 118 in FIG. 3. Thus, a small amount of exhaust gas may flow downwardly into the lower piston section 42. However, as the pressure of the exhaust gas during the exhaust stroke 108 may be much smaller than the pressure of the air/fuel-mixture during the power stroke 106, for example, at maximum about 5 bar, the amount of exhaust gas flowing into the lower piston section 42 is much smaller than the amount of unburned air/fuel-mixture passing from the annular crevice 18 into the lower piston section 42. Particularly, the amount of exhaust gas is negligible as compared to the amount of the regained unburned air/fuel-mixture.

After passing a crank angle of about 635°, which means after passing a crank angle of about 275° after the TDC, the upper edge 33 of the first piston ring 32 passes the upper edge 15 of the venting groove 14, such that the annular crevice 18 gets out of fluid communication with the lower piston section 42.

During a crank angle range from about 635° to 720°, which means a crank angle range from about 275° to 360° after the TDC, the exhaust gas within the combustion chamber 28 is urged out of the same by the piston 30 moving upwardly.

At the end of the exhaust stroke 108, which also defines the end of the four-stroke cycle, the piston 30 is again in the TDC. Then, the above described four-stroke cycle may start again beginning with the intake stroke 102.

When unburned air/fuel-mixture and/or exhaust gas flows into the crankcase, a re-supplying connection (not shown) may be configured to fluidly connect the crankcase to the inlet channel 20, such that the unburned air/fuel-mixture may be re-supplied in a subsequent combustion cycle.

In some embodiments, where the piston 30 comprises only one piston ring sealingly contacting the cylinder 2, the above detailed description may also be applied to such embodiments. Particularly, in such case, the upper edge of the first piston ring 32 may correspond to the upper edge of the only one piston ring, whereas the lower edge of the second piston ring 34 may correspond to the lower edge of the only one piston ring.

Each of the plurality of venting grooves 14, 16 may include a circular cross-section having a depth t in a range from, for example, about 0.2 mm to 1.0 mm, preferably about 0.5 mm. In some embodiments, each of the plurality of venting grooves 14, 16 may comprise any other cross-section suitable to bypass at least the amount of unburned air/fuel-mixture of the annular crevice 18 into the lower-piston portion.

Although the preferred embodiments of this invention have been described herein, improvements and modifications may be incorporated without departing from the scope of the following claims.

1. An internal combustion engine comprising:
a cylinder;
a piston reciprocally movable within the cylinder between a top dead center (TDC) and a bottom dead center (BDC), the piston separating the cylinder into an upper piston section and a lower piston section, the piston including a piston ring assembly with at least one piston ring configured to sealingly contact the cylinder and having a piston ring assembly thickness (D);
an annular crevice having an annular crevice volume and being in fluid communication with the upper piston section and being defined by the cylinder, the piston, and the piston ring assembly; and
a plurality of venting grooves each extending within the cylinder in an axial direction over a length (L) greater than the piston ring assembly thickness (D), the venting grooves having a venting volume and being configured and positioned to fluidly connect the annular crevice with the lower piston section, only when the piston has a position corresponding to a crank angle range of about 85° to 95° and about 265° to 275° after the top dead center (TDC), the venting volume being within the range from 15% to 60% of the annular crevice volume.

2. An internal combustion engine comprising:
a cylinder;
a piston reciprocally movable within the cylinder between a top dead center (TDC) and a bottom dead center (BDC), the piston separating the cylinder into an upper piston section and a lower piston section, the piston including at least one piston ring configured to sealingly contact the cylinder and having a piston ring thickness (D);
an annular crevice being in fluid communication with the upper piston Section and being defined by the cylinder, the piston, and the at least one piston ring; and
a plurality of venting grooves vertically disposed in the cylinder and each having a length (L) greater than the piston ring thickness (D), venting grooves being configured and positioned to fluidly connect the annular crevice with the lower piston section, only when the piston has a position corresponding to a crank angle range of about 85° to 95° and about 265° to 275° after the top dead center (TDC).

3. The internal combustion engine of claim 1, wherein the length (L) of each of the venting grooves is at maximum about 50% greater than the piston ring assembly thickness (D).

4. The internal combustion engine of claim 1, further comprising a cylinder liner inserted into the cylinder, such that the piston is reciprocally disposed within the cylinder liner and the annular crevice is defined by the cylinder liner, the piston, and the piston ring assembly, wherein the venting grooves are disposed in the cylinder liner.

5. The internal combustion engine of claim 4, wherein the venting grooves are symmetrically disposed about a circumference of the cylinder liner.

6. The internal combustion engine of claim 4, wherein each of the venting grooves includes an upper edge that is sloped.

7. The internal combustion engine of claim 4, wherein each of the venting grooves includes a lower edge that is sloped.

8. The internal combustion engine of claim 1, wherein the piston ring assembly thickness (D) is defined by a distance between an upper edge of the at least one piston ring and a lower edge of the at least one piston ring.

9. The internal combustion engine of claim 1, further comprising an inlet channel fluidly connected to the upper piston section and configured to supply an air/fuel-mixture into the upper piston section, wherein the lower piston section is configured to be fluidly connected to the inlet channel, such that unburned air/fuel-mixture is re-supplied to the upper piston section during a subsequent cycle.

10. The internal combustion engine of claim 9, further comprising a crankcase configured to include a crankshaft supporting the piston, wherein the crankcase is configured to be fluidly interconnected between the lower piston section and the inlet channel.

11. The internal combustion engine of claim 10, further comprising a re-supplying channel configured to be fluidly interconnected between the crankcase and the inlet channel.

12. The internal combustion engine of claim 1, wherein the upper piston section defines a combustion chamber configured to combust an air/fuel-mixture within.

13. A method for operating an internal combustion engine including a cylinder defining a combustion chamber (28) within the method comprising:
moving a piston reciprocally within the cylinder between a top dead center (TDC) and a bottom dead center (BDC);
supplying a predetermined amount of an air/fuel-mixture into the combustion chamber; and
directing unburned air/fuel-mixture out of an annular crevice formed between the cylinder and the piston and being in fluid communication with the combustion chamber into an inlet channel, only when the piston has a position corresponding to a crank angle range of about 85° to 95° after the top dead center (TDC) during a power stroke of the internal combustion engine.

14. The method of claim 13, further comprising directing the unburned air/fuel-mixture into a lower piston section disposed below the piston before directing the unburned air/fuel-mixture into the inlet channel.

15. The method of claim 14, wherein directing the unburned air/fuel-mixture into the lower piston section includes bypassing the piston via a plurality of venting grooves.

16. A cylinder liner configured to be inserted into a cylinder of an internal combustion engine, the cylinder liner comprising:
a circumferential wall configured to reciprocally guide a piston between a top dead center (TDC) and a bottom dead center (BDC), the piston separating the cylinder liner into an upper piston section and a lower piston section, and including a piston ring assembly having at least one piston ring configured to sealingly contact the circumferential wall and having a piston ring assembly thickness (D), such that an annular crevice is defined by the circumferential wall, the piston, and the at least one piston ring, the annular crevice having an annular crevice volume; and
a plurality of venting grooves each extending within the cylinder in axial direction over a length (L) being greater than the piston ring assembly thickness (D), the plurality of venting grooves having a venting volume and being configured and positioned to fluidly connect the annular crevice to the lower piston section, only when the piston has a position corresponding to a crank angle range of about 85° to 95° and about 265° to 275° after the top dead center (TDC), the venting volume being in the range from 15% to 60% of the annular crevice volume.

17. A cylinder liner configured to be inserted into a cylinder of an internal combustion engine, the cylinder liner comprising:
a circumferential wall configured to reciprocally guide a piston between a top dead center (TDC) and a bottom dead center (BDC), the piston separating the cylinder liner into an upper piston section and a lower piston section, and including at least one piston ring configured to sealingly contact the circumferential wall and having a piston ring thickness (D), such that an annular crevice is defined by the circumferential wall, the piston, and the at least one piston ring; and
a plurality of venting grooves vertically disposed in the circumferential wall and each of the venting grooves having a length (L) that is greater than the piston ring thickness (D), the venting grooves being configured and positioned to fluidly connect the annular crevice to the lower piston section, only when the piston has a position corresponding to a crank angle range of about 85° to 95° and about 265° to 275° after the top dead center (TDC).

18. The cylinder liner of claim 17, wherein a number of the venting grooves is six.

19. The cylinder liner of claim 17, wherein the venting grooves are symmetrically disposed about a circumference of the cylinder liner.

20. The internal combustion engine of claim 2, wherein a number of the venting grooves is six.
